(19) United States
(12) Patent Application Publication
(10) Pub. No.: US 2008/0201050 A1
(43) Pub. Date: Aug. 21, 2008

(54) Gap indicator for the changing of lanes by a motor vehicle on a multilane road

(76) Inventors: Lars Placke, Hannover (DE); Lars Biester, Bamberg (DE)

Correspondence Address: KENYON & KENYON LLP, ONE BROADWAY, NEW YORK, NY, 10004, US

(21) Appl. No.: 12/069,781

(22) Filed: Feb. 13, 2008

(30) Foreign Application Priority Data
Feb. 15, 2007 (DE) 102007007507.5

(51) Int. Cl. B60W 30/08

(52) U.S. Cl. 701/70

(57) ABSTRACT

The gap indicator includes a surround sensor system for recording the traffic surround field including the traffic in at least one adjacent lane, an identification device for determining gaps in the traffic sufficient for a lane change, and a dialog device for the output of detailed driving instructions to the driver of the host motor vehicle.

### BACKGROUND INFORMATION

In today's state of technological development, no assistance whatsoever is offered to the driver in monitoring the traffic to the rear. However, products such as blind-spot detection and “lane-change assistants” are being introduced into the market. However, in the case of the blind-spot detection, a type of red iris in the outside rearview mirror indicates only whether a vehicle is in the blind spot. In the case of the lane-change assistant, at the moment at which the driver signals or initiates the lane change, it is checked whether a vehicle is located or is approaching in the adjacent lane, and whether this could lead to a critical situation.

In a known lane-change assistant, the desire by the driver to pass is recorded and taken into account, but the acceleration process is first initiated at a later time, namely, when the passing vehicle has moved away with a sufficient safety distance. In the event yet a further vehicle is following this passing vehicle in the adjacent lane, and the gap between these vehicles is too small, the acceleration process continues to be deferred until the second vehicle has also concluded its passing maneuver. In this way, the driver receives very effective assistance in deciding whether and when it is possible to change lanes without danger.

However, the known lane-change assistant takes only the traffic situation at the moment into account, and does not look into the future. Therefore, in heavy traffic, it is unable to supply the driver with any information early on as to when prospectively a danger-free lane change is possible.

### SUMMARY OF THE INVENTION

The present invention offers the advantage of analyzing the entire traffic situation within a limited distance range starting from the host motor vehicle, and early on giving indications to the driver about a gap coming soon for a lane change or passing maneuver, or automatically initiating actions in time. For example, an early driving instruction in the case of heavy traffic could say: “Let vehicles still pass, lane change then possible.”

Thus, the surround sensor system may transmit the colors, heights and lengths of the motor vehicles as additional parameters to the identification device, and the identification device may evaluate these parameters as well, in order to classify these other vehicles. Together with the driving instructions, classification information concerning the other vehicles is then output by the dialog device as an identification aid to the driver of the host motor vehicle.

An early driving instruction in the case of heavy traffic could then say: “Let vehicles still pass, lane change possible after the red car.”

Moreover, the surround sensor system may also transmit the velocity of a motor vehicle in front and its distance from the host motor vehicle as additional parameters to the identification device, and the identification device may evaluate these parameters as well.

A driving instruction could then say: “A lane change is not yet possible. Please brake” or “A lane change is possible after the next blue car. Please accelerate now.”

Furthermore, an additional environmental sensor system may transmit parameters from the set including temperature, precipitation and road-surface covering to the identification device, and the identification device may likewise evaluate these parameters.

In this way, it is possible to take into account whether the road condition allows maximal steering movements, acceleration processes and braking procedures which permit smaller gaps for a lane change, or whether the road condition allows only limited steering movements, acceleration processes and braking procedures, which require large gaps for a lane change.

According to a further refinement, the identification device is able to precalculate future gaps based on continuously evaluated parameters from the set including the velocity of the host vehicle, velocity of the other motor vehicles and their distance from the host motor vehicle, velocity of a preceding motor vehicle and its distance from the host motor vehicle, temperature, precipitation, road-surface covering, and previous acceleration and braking performance of the host vehicle.

In this case, not only are the gaps existing prior to a lane change ascertained, but also, by analysis of historical data, the dynamic changes of the distances between vehicles are estimated on the basis of different velocities and acceleration capabilities, and these estimated values are included in the precalculation of future gaps.

With the aid of the dialogue device, control commands for the manual or self-learning, automatic change of at least one setpoint value are able to be input independently or in dialogue with automatically generated specifications.

The driver thus has the possibility of adapting the characteristics of the gap indicator to his/her personal driving style, or perhaps to the driver's self-assessment of his/her ability to react quickly or slowly.

The dialogue device may be activable by an automatically recognized driver action from the set including actuation of the turn signal, acceleration, braking, and approach to a preceding motor vehicle.

In this way, driving instructions are only output when a lane change is indicated on the basis of the driving behavior, and not in response to every opportunity theoretically presenting itself.

The combination of individual or several of the features according to the present invention permits an optimal design of the overall system performance. The gap indicator is also able to cooperate with a plurality of systems by merging data from further systems such as blind-spot detection, as well as other assistant systems and sensors and, among other things, accessing a user profile of the specific driver. This may be stored at the interface of all controller inputs. Data about the previous settings by the driver at all subsystems, in conjunction with further relevant data such as outside temperature, road condition, etc. may be stored in the user profile.

The possibility also exists to select between the variants via a menu. This selection possibility is first and foremost the responsibility of the driver; however, in certain situations, e.g., if the driver is under great stress, may be carried out adaptively by the system if this promotes safety. On the basis of the data cited above, the system is able to propose setting changes independently, or to make them directly. The system is then able to output the recommendations when the driver signals a passing maneuver. Alternatively, the system may also generate recommendations independently when, by access to another sensor system, e.g., a distance control, it deduces a coming passing maneuver.

However, the driver is able to alter the system specifications independently. The driver always has the opportunity to change the system performance in parts. Thus, for example, the driver has the possibility of switching off the variant of the fully automatic settings. In the cooperative system design, the setting is changed only after a joint negotiation of this change between system and person. In this context,; the person reacts to suggestions of the system, which are adjusted on the part of the system until an agreement has been achieved. In this variant, the actual change of the setting may also be made by the person. The cooperative gap indicator is then used only to suggest or negotiate the optimal gaps.

The features of the present invention also lead to an energy-saving, optimized driving of the host vehicle and to smoother movement of the overall traffic.

### BRIEF DESCRIPTION OF THE DRAWINGS

FIG. 1 shows a block diagram of the present invention.

FIG. 2 shows a depiction of a traffic situation on a multilane road.

### DETAILED DESCRIPTION

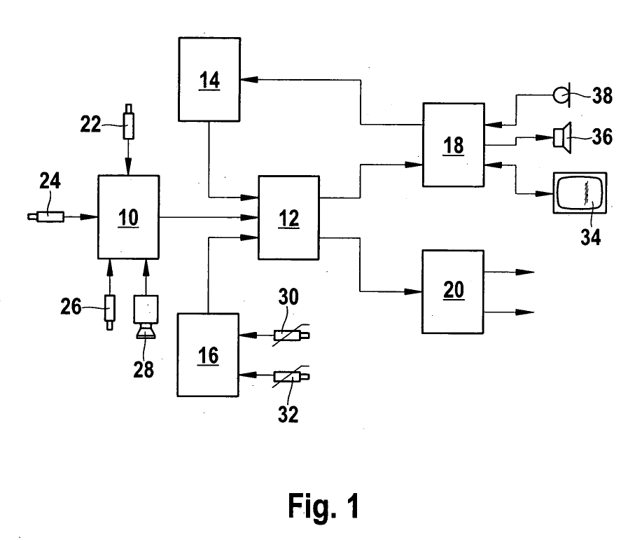

FIG. 1 shows a block diagram of the present invention, having a surround sensor system 10, an identification device 12, a setpoint-value memory 14, a dialog device 18, a control device 20 and an environmental sensor system 16. Surround sensor system 10 includes radar sensors 22, 24, 26 for dynamic distance measurement; from the distance and the time, it is possible to calculate the velocities and acceleration processes of the other motor vehicles or, in conjunction with the velocity of the host vehicle, it is possible to calculate the relative velocities of the other vehicles. Moreover, surround sensor system 10 may also contain a video camera 28 for recording the height and length of motor vehicles in conjunction with the distances ascertained by radar sensors 26, as well as for recording the color.

Setpoint values from the set including velocity, accelerating ability, driver reaction time and gap size are stored in setpoint-value memory 14. User profiles may also be stored. Parameters from the set including temperature, precipitation and road-surface covering are recorded by an environmental sensor system 16 via sensors 30, 32.

Parameters transmitted by surround sensor system 10 and environmental sensor system 16 are compared to setpoint values from setpoint-value memory 14 by identification device 12. By evaluating the parameters and comparing them to the setpoint values, identification device 12 generates control signals which are transmitted to a dialog device 18 or a control device 20. Dialog device 18 includes a combined input and output screen 34, a microphone 38 and a loudspeaker 36. Visual and acoustical driving instructions are thereby able to be conveyed to the driver, and manual or acoustical input commands are able to be received. Setpoint values are able to be changed in setpoint-value memory 14, and user profiles may also be selected using the input commands.

Vehicle systems may also be influenced by control device 20, for example, acceleration commands may be transmitted to the drive system or braking commands may be transmitted to the brake system.

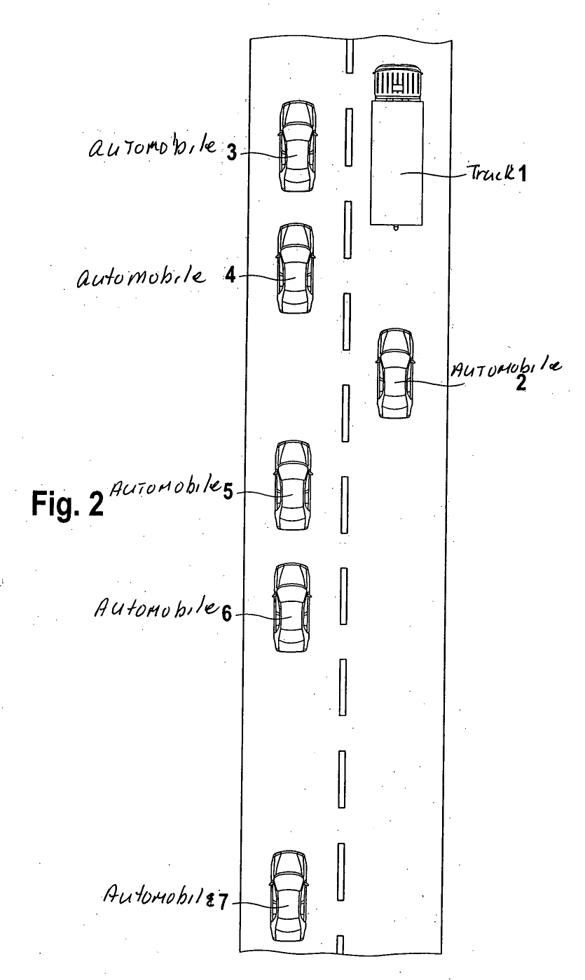

The functioning of the gap indicator is described based on a depiction of a traffic situation on a multilane road shown in FIG. 2. In order to be able to pass slower-moving truck 1 with the necessary clearances, automobile 2 needs a sufficiently large gap between automobiles 3-7. This really does not exist between automobiles 4 and 5, but rather first between automobiles 6 and 7. Taking the first gap would lead to a dangerous situation for the traffic to the rear.

Surround sensor system 10 records distances of all vehicles in the distance range, shown in FIG. 2, from host automobile 2, and in conjunction with the velocity of the host vehicle, calculates the relative velocity with respect to preceding truck 1 as well as with respect to automobiles 3 through 7 located in the adjacent lane. The relative spacings between automobiles 3 through 7 are obtained from the distances.

In the setpoint-value memory, data is stored which, according to the velocity of the host vehicle, permits a minimum gap satisfying the traffic regulations for a lane change by automobile 2 without danger. The result of the comparison shows that a sufficient gap first exists between automobiles 6 and 7. Accordingly, a control command is transmitted to dialog device 18, which outputs to the driver a driving recommendation in the following manner: “Let two automobiles pass. After that, lane change possible.”

What is claimed is:

1. A gap indicator for a changing of lanes by a first motor vehicle on a multilane road, comprising:
a surround sensor system for recording a traffic surround field including traffic in at least one adjacent lane, the surround sensor system including a distance measuring instrument, a length measuring instrument and a velocity measuring instrument for all other motor vehicles to the rear and to the side, detected within a limited distance range starting from the first motor vehicle, in the at least one adjacent lane; and
an identification device for determining gaps in the traffic sufficient for a lane change, wherein, by comparing parameters of a velocity of the first motor vehicle and velocities of the other motor vehicles and their distances from the first motor vehicle to setpoint values from a set including velocity, accelerating ability, driver-reaction time and gap size, the identification device predictively ascertains a coming gap sufficient for a lane change and outputs acceleration commands to an engine or deceleration commands to a brake system with the aid of a control device, or outputs detailed driving instructions to a driver of the first motor vehicle with the aid of a dialog device.

2. The gap indicator according to claim 1, wherein the surround sensor system transmits colors, heights and lengths of the motor vehicles as additional parameters to the identification device, and the identification device likewise evaluates these parameters for classifying the other vehicles, and together with the driving instructions, outputs classification data concerning the other vehicles as an identification aid to the driver of the first motor vehicle with the aid of the dialog device.

3. The gap indicator according to claim 1, wherein the surround sensor system transmits a velocity of a preceding motor vehicle and its distance from the first motor vehicle as additional parameters to the identification device, and the identification device evaluates these parameters as well.

4. The gap indicator according to claim 1, further comprising an environmental sensor system that transmits parameters from the set including temperature, precipitation and road-surface covering to the identification device, and the identification device evaluates these parameters as well.

5. The gap indicator according to claim 1, wherein the identification device precalculates future gaps based on continuously evaluated parameters from the set including the velocity of the first motor vehicle, velocities of the other motor vehicles and their distance from the first motor vehicle, a velocity of a preceding motor vehicle and its distance from the first motor vehicle, temperature, precipitation, road-surface covering and previous acceleration and braking performance of the first motor vehicle.

6. The gap indicator according to claim 1, wherein with the aid of the dialog device, control commands for a manual or self-learning, automatic change of at least one setpoint value are input independently or in dialogue with automatically generated specifications.

7. The gap indicator according to claim 1, wherein the dialog device is activated by an automatically recognized driver action from the set including actuation of turn signal, acceleration, braking and approach to a preceding motor vehicle.
